(19) United States
(12) Patent Application Publication
(10) Pub. No.: US 2025/0305533 A1
(43) Pub. Date: Oct. 2, 2025

(54) Fasteners

(71) Applicant: Shakespeare Machine Stamping, Racine, WI (US)

(72) Inventor: James Haarsma, Racine, WI (US)

(21) Appl. No.: 19/093,837

(22) Filed: Mar. 28, 2025

Related U.S. Application Data
(60) Provisional application No. 63/571,851, filed on Mar. 29, 2024.

(51) Int. Cl. F16B 23/00

(52) U.S. Cl. CPC F16B 23/00

(57) ABSTRACT

Various embodiments of fasteners for abrasive devices, such as wheels, are provided. The fasteners include a central body, a platform extending outward from the central body. At least a portion of the central body is configured to facilitate securing the fastener to an object, thereby coupling an abrasive device to the object.

### CROSS-REFERENCE TO RELATED PATENT APPLICATION

The present application claims the benefit of and priority to U.S. Provisional Application No. 63/571,851, filed on Mar. 29, 2024, which is incorporated herein by reference in its entirety.

### BACKGROUND OF THE INVENTION

The present invention relates generally to the field of abrasive wheels. The present invention relates specifically to a fasteners for abrasive wheels.

### SUMMARY OF THE INVENTION

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments. In addition, alternative exemplary embodiments relate to other features and combinations of features as may be generally recited in the claims.

### BRIEF DESCRIPTION OF THE DRAWINGS

This application will become more fully understood from the following detailed description, taken in conjunction with the accompanying figures, wherein like reference numerals refer to like elements in which:

FIG. 1 is a perspective view of a fastener being used to secure an abrasive wheel, according to an exemplary embodiment.

FIG. 2 is a perspective view of the fastener of FIG. 1, according to an exemplary embodiment.

FIG. 3 is a side view of the fastener of FIG. 1, according to an exemplary embodiment.

FIG. 4 is a top view of the fastener of FIG. 1, according to an exemplary embodiment.

FIG. 5 is a cross-section view of the fastener of FIG. 3 taken along line 4-4 in FIG. 3, according to an exemplary embodiment.

FIG. 6 is a perspective view of another fastener, according to an exemplary embodiment.

FIG. 7 is a perspective view of another fastener, according to an exemplary embodiment.

FIG. 8 is a perspective view of another fastener, according to an exemplary embodiment.

FIG. 9 is a perspective view of another fastener, according to an exemplary embodiment.

FIG. 10 is a perspective view of another fastener, according to an exemplary embodiment.

FIG. 11 is a perspective view of another fastener, according to an exemplary embodiment.

FIG. 12 is a perspective view of another fastener, according to an exemplary embodiment.

FIG. 13 is a perspective view of another fastener, according to an exemplary embodiment.

FIG. 14 is a perspective view of another fastener, according to an exemplary embodiment.

FIG. 15 is a perspective view of another fastener, according to an exemplary embodiment.

FIG. 16 is a perspective view of another fastener, according to an exemplary embodiment.

FIG. 17 is a perspective view of another fastener, according to an exemplary embodiment.

FIG. 18 is a perspective view of another fastener, according to an exemplary embodiment.

FIG. 19 is a perspective view of another fastener, according to an exemplary embodiment.

FIG. 20 is a perspective view of another fastener, according to an exemplary embodiment.

FIG. 21 is a perspective view of another fastener, according to an exemplary embodiment.

FIG. 22 is a perspective view of another fastener, according to an exemplary embodiment.

FIG. 23 is a perspective view of another fastener, according to an exemplary embodiment.

FIG. 24 is a perspective view of another fastener, according to an exemplary embodiment.

FIG. 25 is a perspective view of another fastener, according to an exemplary embodiment.

FIG. 26 is a perspective view of another fastener, according to an exemplary embodiment.

### DETAILED DESCRIPTION

Referring generally to the figures, various embodiments of a fastener for abrasive wheels are shown. Applicant has observed that the embodiments described herein provide higher torque test rating for the grinding wheel, and greatly improves removal of the grinding wheel from the power tool without damage compared to similar devices on the market. In particular, Applicant has observed that providing an increased area, relative to other fasteners for the exterior surface of the central body above the platform facilitates tightening and loosening the fastener.

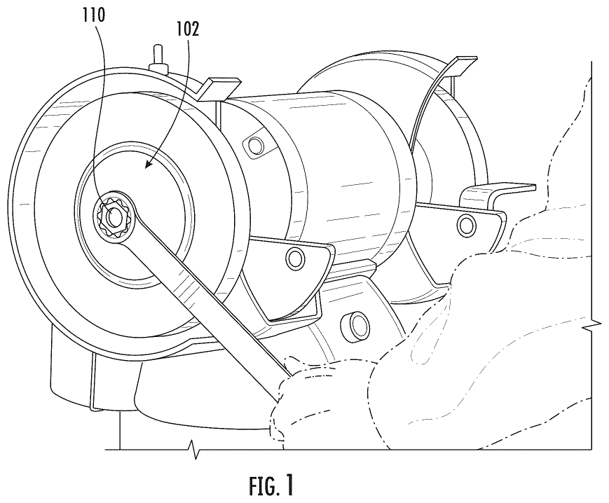

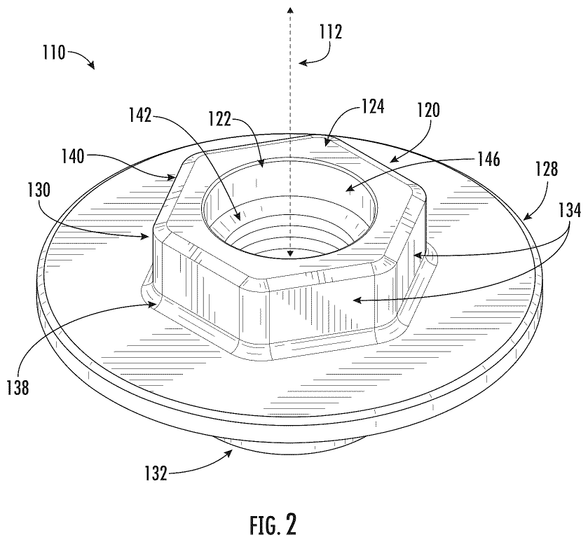

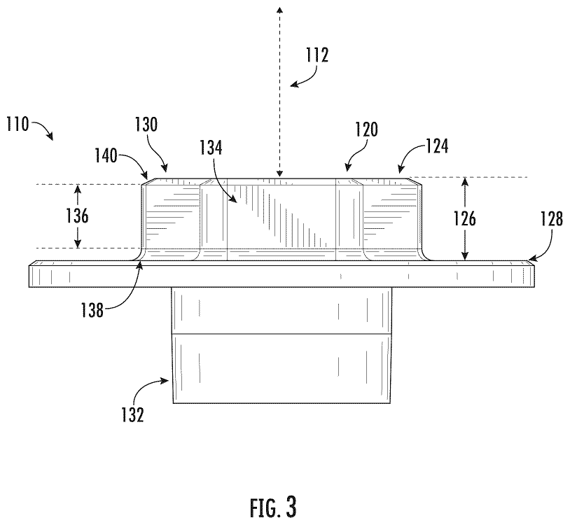

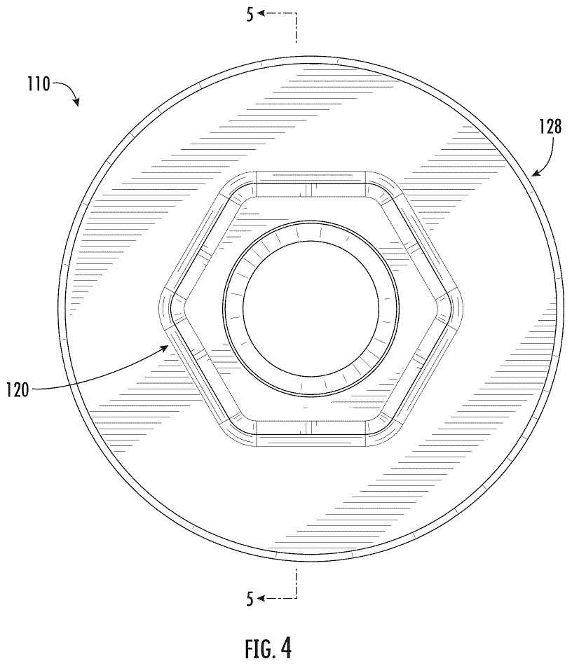

Referring to FIGS. 1-5, various aspects of fastener 110 are shown. Fastener 110 is configured to secure an abrasive wheel 102, such as to a machine that rotates the abrasive wheel 102 at speeds sufficient to grind an object being pressed against the abrasive wheel 102 while rotating. Fastener 110 includes a central body 120 extending along and centered on a longitudinal axis 112, a threading 142, and a platform 128 extending radially from the central body 120 away from the longitudinal axis 112. Central body 120 defines defining an inner surface 122 that faces inward towards the longitudinal axis 112, and central body 120 defines an upper surface 124 that defines a plane perpendicular to the longitudinal axis 112. Threading 142 extends from the inner surface 122 towards the longitudinal axis 112.

Central body 120 defines an upper portion 130 above the platform 128 and a lower portion 132 below the platform 128. Upper surface 124 is defined by the upper portion 130 and faces away from the platform 128. Platform 128 and upper surface 124 define distance 126 therebetween that is measured along the longitudinal axis 112.

In various embodiments, fastener 110 includes a securing element, shown as surfaces 134 defined in the upper portion 130 and that face away from the longitudinal axis 112. In various embodiments the securing element is defined in the upper portion 130 and faces away from the longitudinal axis 112, and the securing element extends a distance 136 that is at least 80% of the distance 126 between the platform 128 and the upper surface 124. In various embodiments, the securing element is symmetrically arranged around the longitudinal axis 112.

In various embodiments, surfaces 134 extend a distance 136 that is at least 50% of distance 126 between the platform 128 and the upper surface 124, and more specifically at least 60%, and even more specifically at least 70%, and even more specifically at least 80%, and even more specifically at least 90%. Applicant has observed that providing an increased distance 136 of surfaces 134 relative to other fasteners facilitates users using fasteners 110 to secure abrasive objects, such as discs and/or wheels.

In various embodiments, fastener 110 includes a plurality of planar surfaces 134 that are collectively symmetrically arranged around the longitudinal axis 112. In various embodiments, the plurality of planar surfaces 134 consist of six surfaces configured to interface with a hex fastening device (e.g., pliers, a socket wrench).

Fastener 110 includes a first tapering 138 between the surfaces 134 (e.g., plurality of planar surfaces 134) and the platform 128. In various embodiments, first tapering 138 extends upward and towards the longitudinal axis 112 as the first tapering 138 transitions from the platform 128 to the plurality of planar surfaces 134.

Fastener 110 includes a second tapering 140 between the surfaces 134 (e.g., plurality of planar surfaces 134) and the upper surface 124. In various embodiments, the second tapering 140 extends upward and towards the longitudinal axis 112 as the second tapering 140 transitions from the plurality of planar surfaces 134 to the upper surface 124.

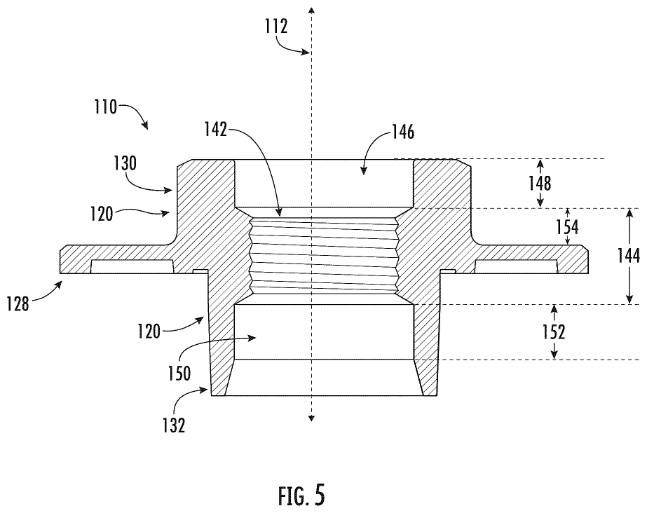

Referring to FIG. 5, inner surface 122 defines a curved upper inner surface 146 above the threading 142, the curved upper inner surface 146 defining a cylindrical shape that faces towards the longitudinal axis 112. In various embodiments, the curved upper inner surface 146 extends a distance 148 below the upper surface 124 of at least 0.1″, or more specifically at least 0.2″, or even more specifically at least 0.25″.

Inner surface 122 defines a curved lower inner surface 150 below the threading 142, the curved lower inner surface 150 defining a cylindrical shape that faces towards the longitudinal axis 112.

In various embodiments, curved upper inner surface 146 extends a first distance 148 below the upper surface 124, threading 142 defines a second distance 144 as measured along the longitudinal axis 122, and the first distance 148 is at least 10% of the second distance 144, and more specifically at least 15%, and more specifically at least 20%, and more specifically at least 25%.

In various embodiments, the curved upper inner surface 146 extends a first distance 148 below the upper surface 124, the threading 142 extends a second distance 154 above the platform 128 as measured along the longitudinal axis 112, and the first distance 148 is greater than the second distance 154.

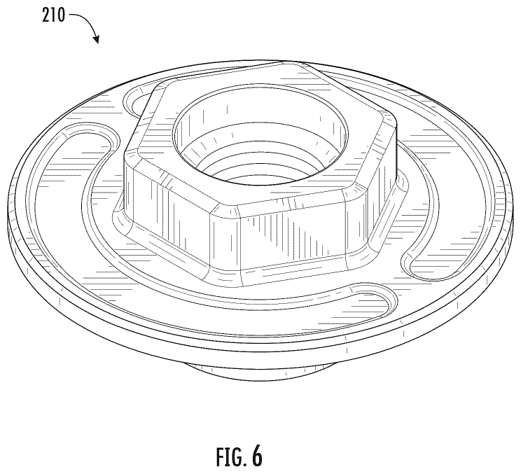

Referring to FIG. 6, fastener 210 is shown according to an exemplary embodiment. Fastener 210 is substantially the same as the other fasteners described herein, and in particular fastener 110.

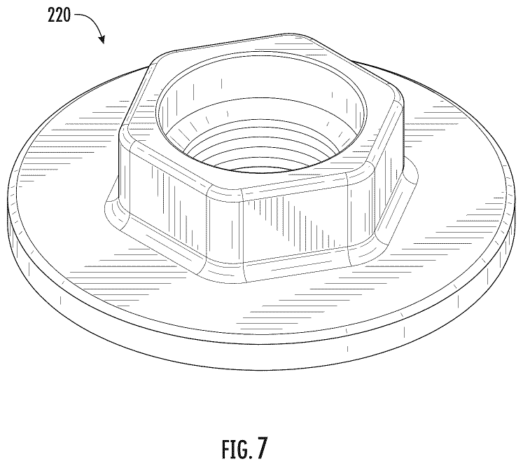

Referring to FIG. 7, fastener 220 is shown according to an exemplary embodiment. Fastener 210 is substantially the same as the other fasteners described herein, and in particular fastener 110.

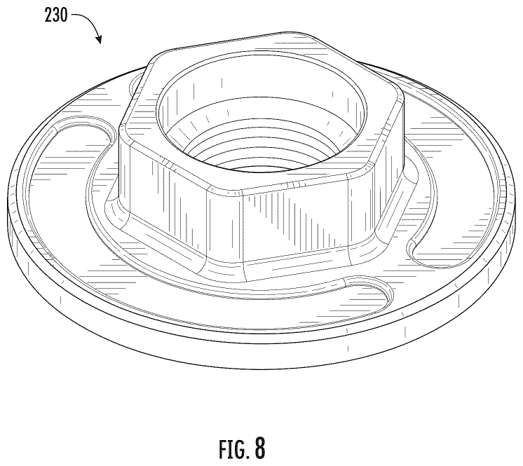

Referring to FIG. 8, fastener 230 is shown according to an exemplary embodiment. Fastener 210 is substantially the same as the other fasteners described herein, and in particular fastener 110.

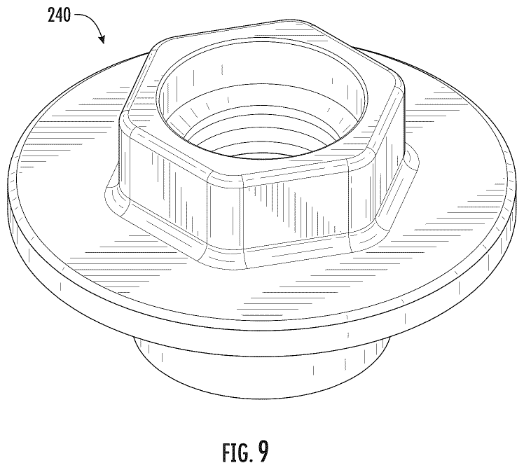

Referring to FIG. 9, fastener 240 is shown according to an exemplary embodiment. Fastener 210 is substantially the same as the other fasteners described herein, and in particular fastener 110.

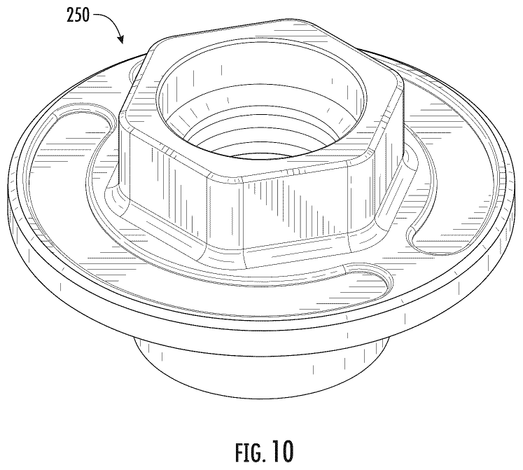

Referring to FIG. 10, fastener 250 is shown according to an exemplary embodiment. Fastener 210 is substantially the same as the other fasteners described herein, and in particular fastener 110.

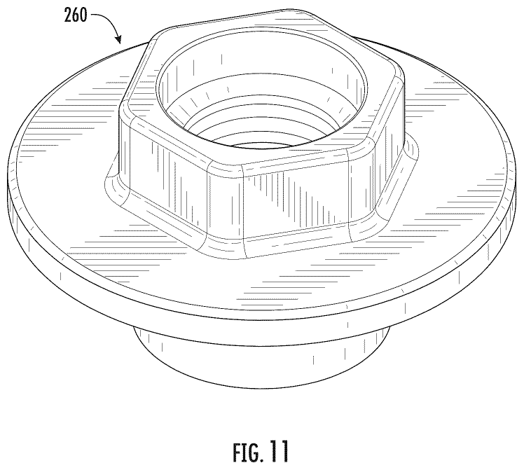

Referring to FIG. 11, fastener 260 is shown according to an exemplary embodiment. Fastener 210 is substantially the same as the other fasteners described herein, and in particular fastener 110.

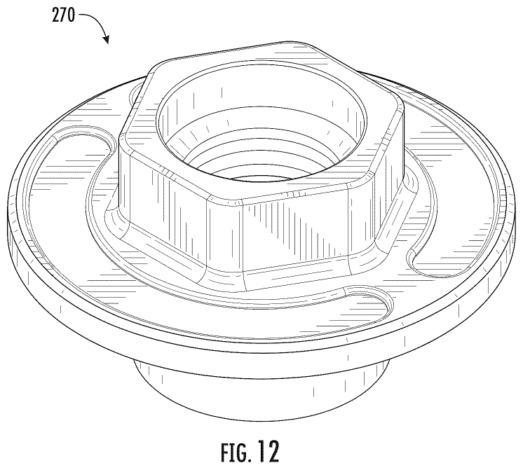

Referring to FIG. 12, fastener 270 is shown according to an exemplary embodiment. Fastener 210 is substantially the same as the other fasteners described herein, and in particular fastener 110.

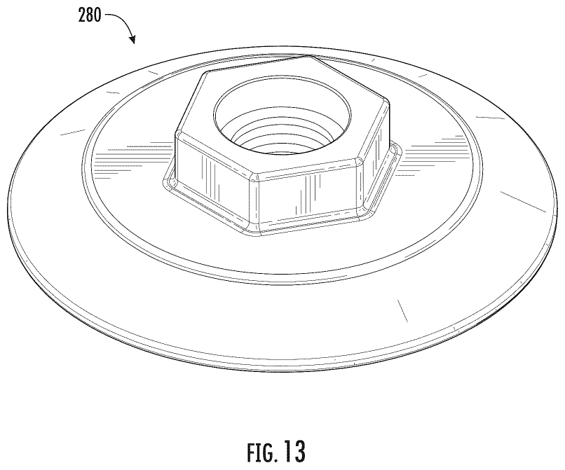

Referring to FIG. 13, fastener 280 is shown according to an exemplary embodiment. Fastener 210 is substantially the same as the other fasteners described herein, and in particular fastener 110.

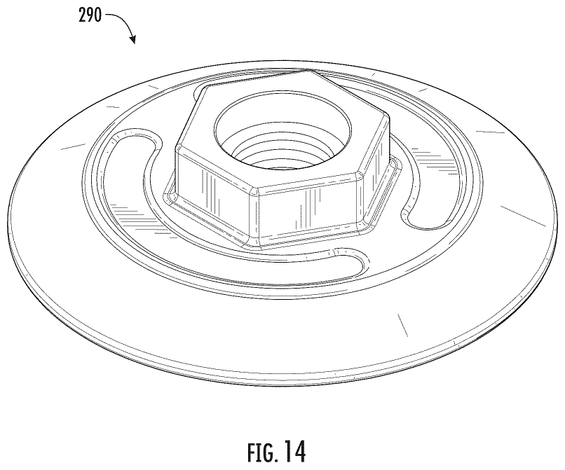

Referring to FIG. 14, fastener 290 is shown according to an exemplary embodiment. Fastener 210 is substantially the same as the other fasteners described herein, and in particular fastener 110.

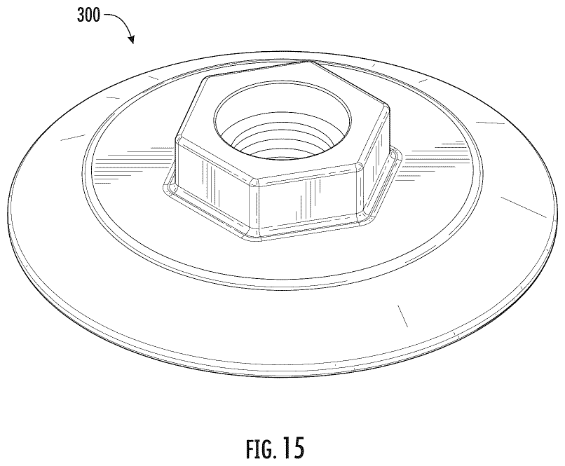

Referring to FIG. 15, fastener 300 is shown according to an exemplary embodiment. Fastener 210 is substantially the same as the other fasteners described herein, and in particular fastener 110.

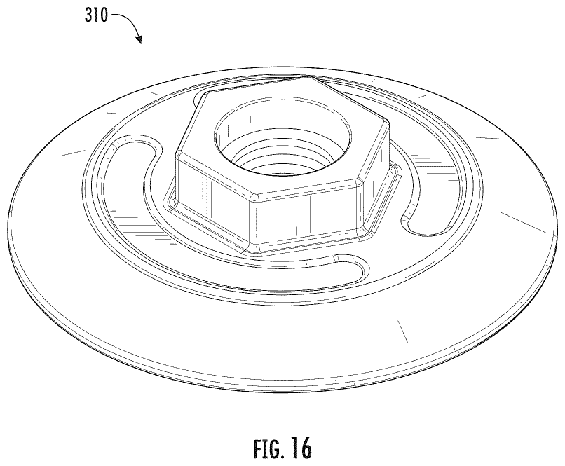

Referring to FIG. 16, fastener 310 is shown according to an exemplary embodiment. Fastener 210 is substantially the same as the other fasteners described herein, and in particular fastener 110.

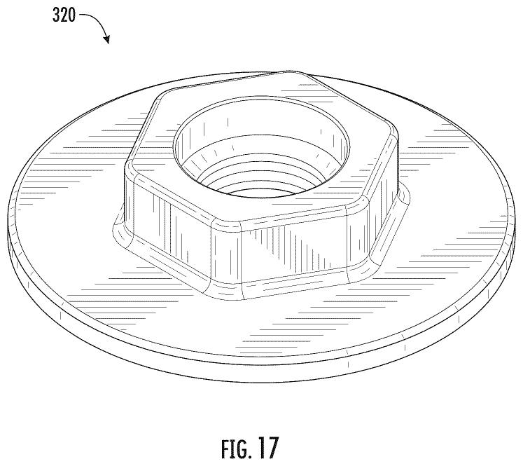

Referring to FIG. 17, fastener 320 is shown according to an exemplary embodiment. Fastener 210 is substantially the same as the other fasteners described herein, and in particular fastener 110.

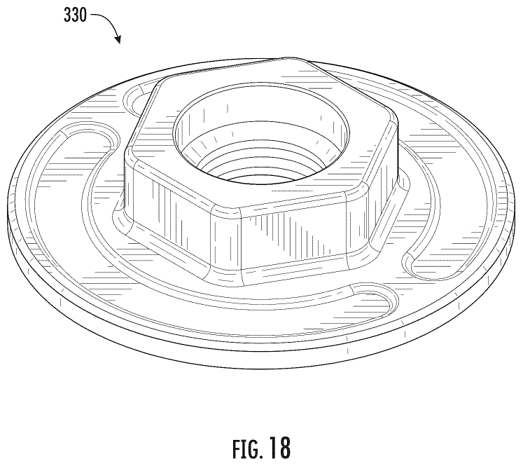

Referring to FIG. 18, fastener 330 is shown according to an exemplary embodiment. Fastener 210 is substantially the same as the other fasteners described herein, and in particular fastener 110.

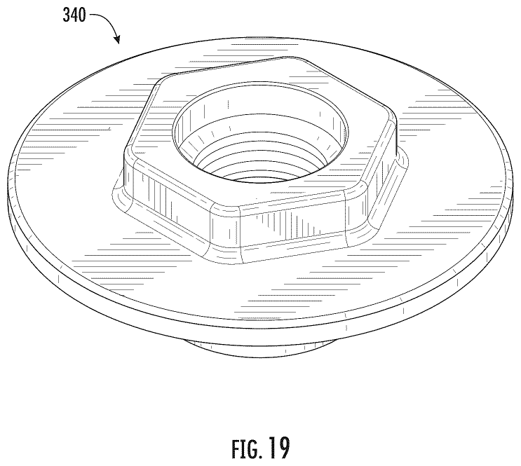

Referring to FIG. 19, fastener 340 is shown according to an exemplary embodiment. Fastener 210 is substantially the same as the other fasteners described herein, and in particular fastener 110.

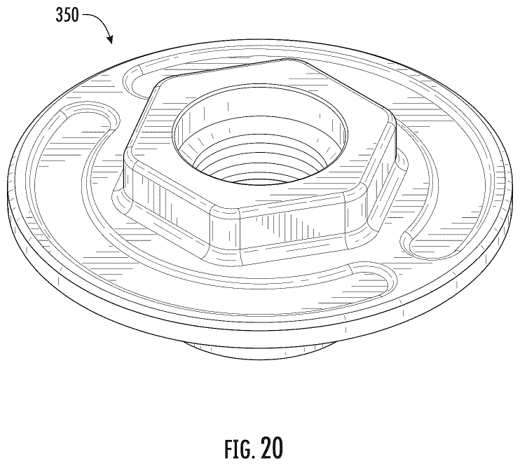

Referring to FIG. 20, fastener 350 is shown according to an exemplary embodiment. Fastener 210 is substantially the same as the other fasteners described herein, and in particular fastener 110.

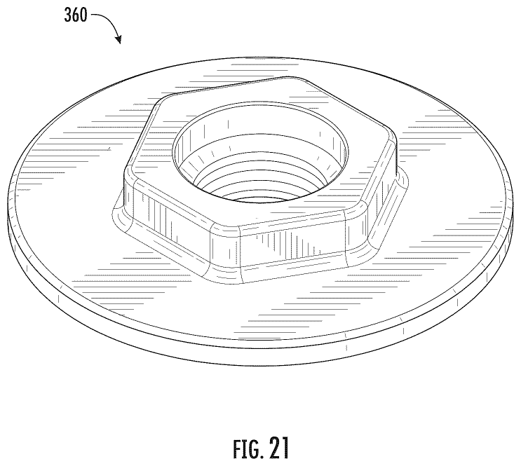

Referring to FIG. 21, fastener 360 is shown according to an exemplary embodiment. Fastener 210 is substantially the same as the other fasteners described herein, and in particular fastener 110.

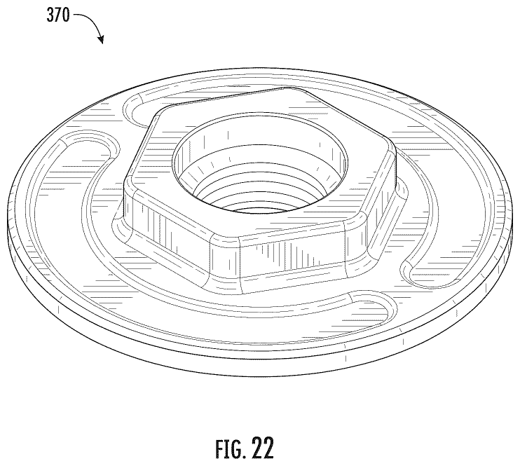

Referring to FIG. 22, fastener 370 is shown according to an exemplary embodiment. Fastener 210 is substantially the same as the other fasteners described herein, and in particular fastener 110.

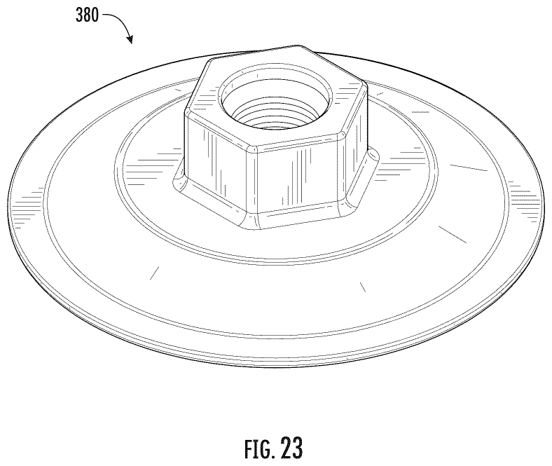

Referring to FIG. 23, fastener 380 is shown according to an exemplary embodiment. Fastener 210 is substantially the same as the other fasteners described herein, and in particular fastener 110.

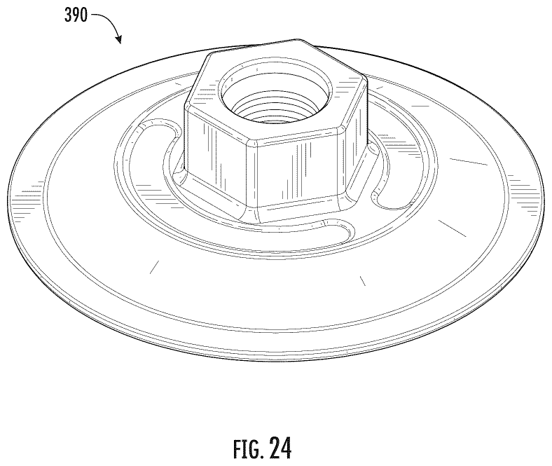

Referring to FIG. 24, fastener 390 is shown according to an exemplary embodiment. Fastener 210 is substantially the same as the other fasteners described herein, and in particular fastener 110.

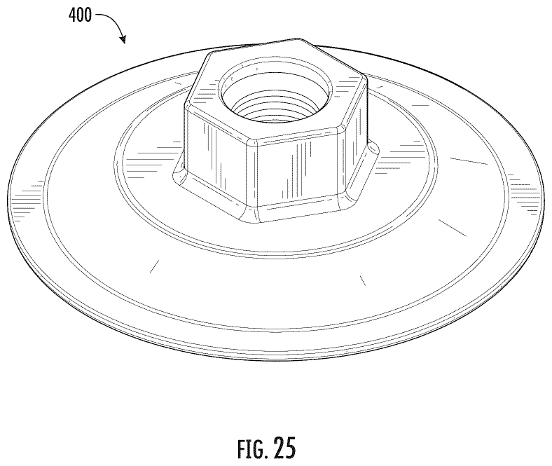

Referring to FIG. 25, fastener 400 is shown according to an exemplary embodiment. Fastener 210 is substantially the same as the other fasteners described herein, and in particular fastener 110.

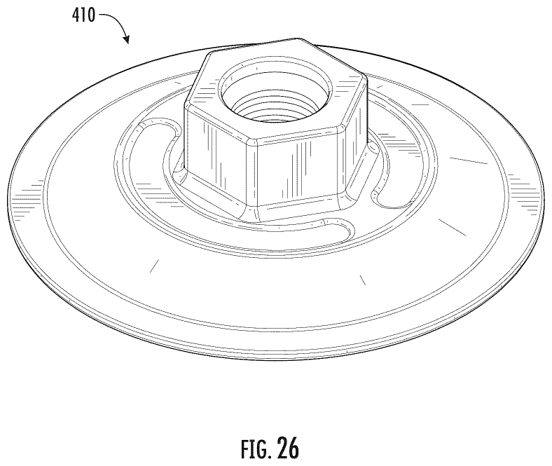

Referring to FIG. 26, fastener 410 is shown according to an exemplary embodiment. Fastener 210 is substantially the same as the other fasteners described herein, and in particular fastener 110.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A fastener comprising:
a central body extending along and centered on a longitudinal axis, the central body defining an inner surface that faces inward towards the longitudinal axis, the central body defining an upper surface that defines a plane perpendicular to the longitudinal axis;
a threading extending from the inner surface towards the longitudinal axis;
a platform extending radially from the central body away from the longitudinal axis, wherein the central body defines an upper portion above the platform and a lower portion below the platform, the upper surface defined by the upper portion and facing away from the platform, the platform and the upper surface defining a distance therebetween that is measured along the longitudinal axis; and
a plurality of planar surfaces defined in the upper portion and that face away from the longitudinal axis, the plurality of planar surfaces extending at least 80% of the first distance between the platform and the upper surface.

2. The fastener of claim 1, wherein the plurality of planar surfaces are collectively symmetrically arranged around the longitudinal axis.

3. The fastener of claim 2, wherein the plurality of planar surfaces consist of six surfaces configured to interface with a hex fastening device.

4. The fastener of claim 1, comprising a first tapering between the plurality of planar surfaces and the platform.

5. The fastener of claim 4, wherein the first tapering extends upward and towards the longitudinal axis as the first tapering transitions from the platform to the plurality of planar surfaces.

6. The fastener of claim 1, comprising a second tapering between the plurality of planar surfaces and the upper surface.

7. The fastener of claim 6, wherein the second tapering extends upward and towards the longitudinal axis as the second tapering transitions from the plurality of planar surfaces to the upper surface.

8. The fastener of claim 1, wherein the inner surface defines a curved upper inner surface above the threading, the curved upper inner surface defining a cylindrical shape that faces towards the longitudinal axis.

9. The fastener of claim 8, wherein the curved upper inner surface extends a distance below the upper surface of at least 0.25″.

10. The fastener of claim 8, wherein the inner surface defines a curved lower inner surface below the threading, the curved lower inner surface defining a cylindrical shape that faces towards the longitudinal axis.

11. A fastener comprising:
a central body extending along and centered on a longitudinal axis, the central body defining an inner surface that faces inward towards the longitudinal axis, the central body defining an upper surface that defines a plane perpendicular to the longitudinal axis;
a threading extending from the inner surface towards the longitudinal axis;
a platform extending radially from the central body away from the longitudinal axis, wherein the central body defines an upper portion above the platform and a lower portion below the platform, the upper surface defined by the upper portion and facing away from the platform, the platform and the upper surface defining a distance therebetween that is measured along the longitudinal axis; and
a securing element defined in the upper portion that face away from the longitudinal axis, the securing element extending at least 80% of the first distance between the platform and the upper surface.

12. The fastener of claim 11, wherein the securing element is symmetrically arranged around the longitudinal axis.

13. The fastener of claim 11, comprising a first tapering between the plurality of planar surfaces and the platform, wherein the first tapering extends upward and towards the longitudinal axis as the first tapering transitions from the platform to the plurality of planar surfaces.

14. The fastener of claim 11, comprising a second tapering between the plurality of planar surfaces and the upper surface, wherein the second tapering extends upward and towards the longitudinal axis as the second tapering transitions from the plurality of planar surfaces to the upper surface.

15. The fastener of claim 11, wherein the inner surface defines a curved upper inner surface above the threading, the curved upper inner surface defining a cylindrical shape that faces towards the longitudinal axis, wherein the curved upper inner surface extends a first distance below the upper surface, wherein the threading defines a second distance as measured along the longitudinal axis, and wherein the first distance is at least 25% of the second distance.

16. A fastener comprising:
a central body extending along and centered on a longitudinal axis, the central body defining an inner surface that faces inward towards the longitudinal axis, the central body defining an upper surface that defines a plane perpendicular to the longitudinal axis;
a threading extending from the inner surface towards the longitudinal axis;
a platform extending radially from the central body away from the longitudinal axis, wherein the central body defines an upper portion above the platform and a lower portion below the platform, the upper surface defined by the upper portion and facing away from the platform, the platform and the upper surface defining a distance therebetween that is measured along the longitudinal axis; and
a plurality of surfaces defined in the upper portion that face away from the longitudinal axis, the plurality of surfaces extending at least 80% of the first distance between the platform and the upper surface, configured to interface with a fastening device to couple the central body to a threaded object.

17. The fastener of claim 16, wherein the plurality of surfaces are collectively symmetrically arranged around the longitudinal axis.

18. The fastener of claim 16, comprising a first tapering between the plurality of planar surfaces and the platform, wherein the first tapering extends upward and towards the longitudinal axis as the first tapering transitions from the platform to the plurality of planar surfaces.

19. The fastener of claim 16, comprising a second tapering between the plurality of planar surfaces and the upper surface, wherein the second tapering extends upward and towards the longitudinal axis as the second tapering transitions from the plurality of planar surfaces to the upper surface.

20. The fastener of claim 16, wherein the inner surface defines a curved upper inner surface above the threading, the curved upper inner surface defining a cylindrical shape that faces towards the longitudinal axis, wherein the curved upper inner surface extends a first distance below the upper surface, wherein the threading extends a second distance above the platform as measured along the longitudinal axis, and wherein the first distance is greater than the second distance.
